(19) United States
(12) Patent Application Publication
(10) Pub. No.: US 2011/0157110 A1
(43) Pub. Date: Jun. 30, 2011

(54) PIXEL STRUCTURE AND ELECTROLUMINESCENCE DEVICE

(75) Inventors: Chia-Ling Chou, Changhua County (TW); Yuan-Chun Wu, Taoyuan County (TW); Lee-Hsun Chang, Hsinchu County (TW)

(73) Assignee: AU OPTRONICS CORPORATION, Hsinchu (TW)

(21) Appl. No.: 12/721,568

(22) Filed: Mar. 11, 2010

(30) Foreign Application Priority Data
Dec. 29, 2009 (TW) 98145642

(51) Int. Cl. G06F 3/038

(52) U.S. Cl. 345/205; 345/80

(57) ABSTRACT

A pixel structure is disposed in a display region which includes a light-emitting region and a non-light-emitting region. The pixel structure has a first active device, a second active device, a light emitting device and an auxiliary electrode layer. The first active device is electrically connected with a scan line and a data line. The second active device is electrically connected with the first active device and a power line. The light emitting device is disposed in the light-emitting region and includes a first electrode layer electrically connected with the second active device, a light emitting layer disposed on the first electrode layer and a second electrode layer disposed on the light emitting layer. The auxiliary electrode layer is electrically connected with the power line.

### CROSS-REFERENCE TO RELATED APPLICATION

This application claims the priority benefit of Taiwan application serial no. 98145642, filed on Dec. 29, 2009. The entirety of the above-mentioned patent application is hereby incorporated by reference herein and made a part of specification.

### BACKGROUND OF THE INVENTION

1. Field of the Invention

The present invention relates to a pixel structure, and more particularly, to a pixel structure of an electroluminescence device.

2. Description of Related Art

The electroluminescence display is a self-emissive display. The electroluminescence device has the advantages of no view angle limit, low fabrication cost, high response speed (about more than one hundred times faster than the response speed of the liquid crystal), power saving, adaptability to direct current driving in portable devices, broad operating temperature range, light weight, as well as providing miniature and low-profile design. Therefore, the electroluminescent device has great potential for development, and is expected to be the new flat panel display of the next-generation.

One typical electroluminescence device includes a top electrode layer, a bottom electrode layer, and a light emitting layer sandwiched between the two electrode layers. And the bottom electrode layer is usually made of a transparent conductive material for transmission of lights emitted by the light emitting layer. However, as the electroluminescence device becomes larger and larger in size, a voltage drop occurred due to the resistance of the power lines may cause a brightness difference between the pixels adjacent to the power input end and that far away from the power input end. Because luminance of each pixel of the electroluminescence device depends on the current flowing through that pixel, the voltage difference would result in the poor overall light emitting uniformity of the electroluminescence device.

### SUMMARY OF THE INVENTION

A pixel structure of an electroluminescence device is provided, which is disposed in a display region having a light-emitting region and a non-light-emitting region. The pixel structure includes a first active device, a second active device, a light emitting device and an auxiliary electrode layer. The first active device is electrically connected with a scan line and a data line. The second active device is electrically connected with the first active device and a power line. The light emitting device is disposed in the light-emitting region and includes a first electrode layer electrically connected with the second active device, a light emitting layer disposed on the first electrode layer and a second electrode layer disposed on the light emitting layer. The auxiliary electrode layer is electrically connected with the power line.

The present invention provides an electroluminescence device including a substrate, a plurality of scan lines, a plurality of data lines, at least a power line and a plurality of pixel structures. The substrate has a display region including a light-emitting region and a non-light-emitting region. The scan lines and the data lines are disposed in the non-light-emitting region. The pixel structures are disposed in the display region and each pixel structure includes a first active device electrically connected with one corresponding scan line and one corresponding data line, a second active device electrically connected with the first active device and the power line, a light emitting device disposed in the light-emitting region and electrically connected with the second active device, and an auxiliary electrode layer electrically connected with the power line. The light emitting device comprises a first electrode layer electrically connected with the second active device, a light emitting layer disposed on the first electrode layer, and a second electrode layer disposed on the light emitting layer.

The present invention provides a pixel structure including a first active device, a second active device, an electrode layer and an auxiliary electrode layer. The first active device is electrically connected with the scan line and the data line. The second active device is electrically connected with the first active device and a power line. The electrode layer is electrically connected with the second active device. The auxiliary electrode layer is electrically connected with the power line.

According to the aforementioned, the pixel structure has the auxiliary electrode layer therein and the auxiliary electrode layer is electrically connected with the power line, such that the auxiliary electrode layer and the power line are electrically connected in parallel. Comparing with the conventional method which only uses the power line, the present invention can reduce the equivalent resistance of the power line to resolve obvious voltage drops occurred at different positions of the power line.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a top view of an electroluminescence device according to one embodiment of the present invention.

FIG. 2 is a top view of a portion of the pixel array of the electroluminescence device of FIG. 1.

FIG. 3A is a schematic cross-sectional view of a portion of a pixel structure according to an embodiment of the present invention.

FIG. 3B is a schematic cross-sectional view of a pixel structure according to an embodiment of the present invention.

FIG. 4 shows an electroluminescence device according to one embodiment of the present invention.

FIG. 5 shows an electroluminescence device according to another embodiment of the present invention.

### DESCRIPTION OF EMBODIMENTS

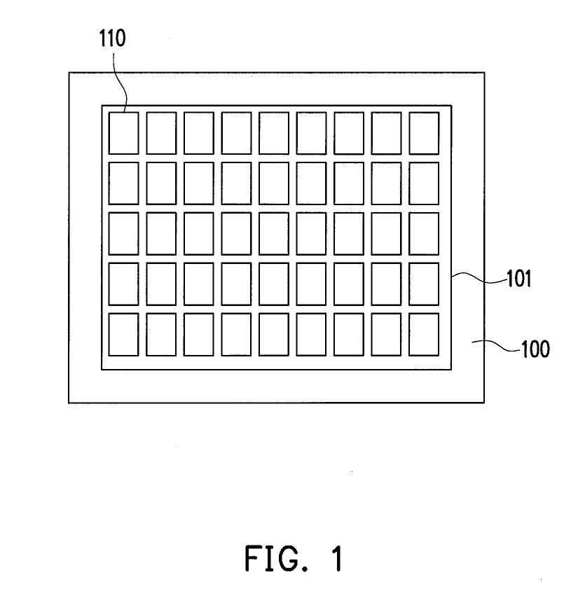

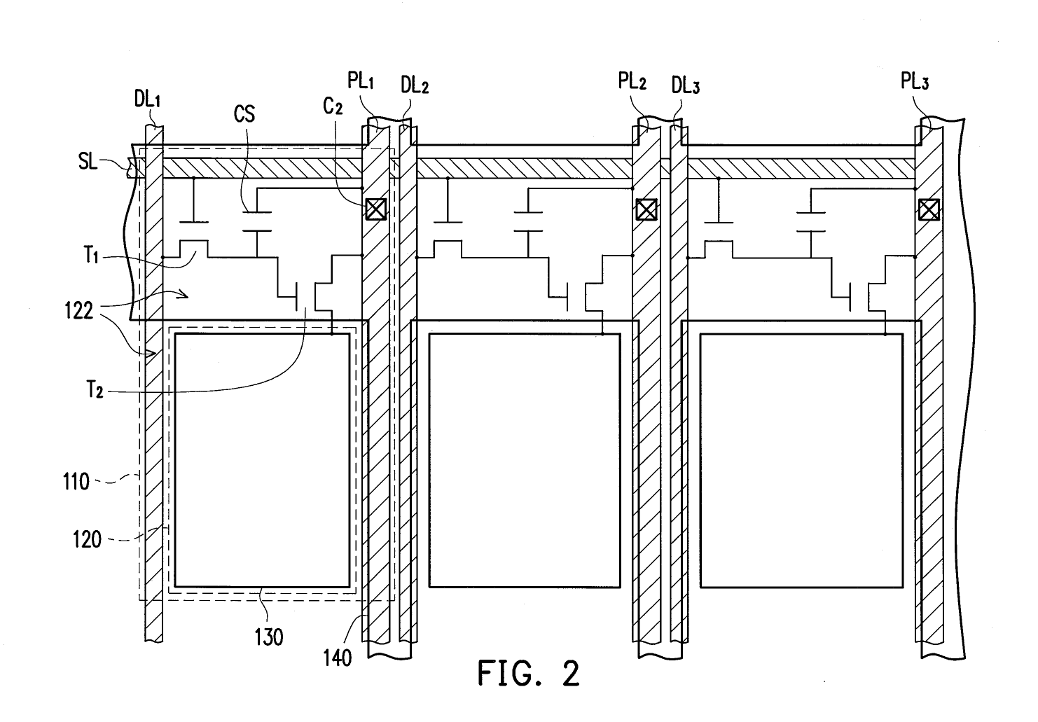

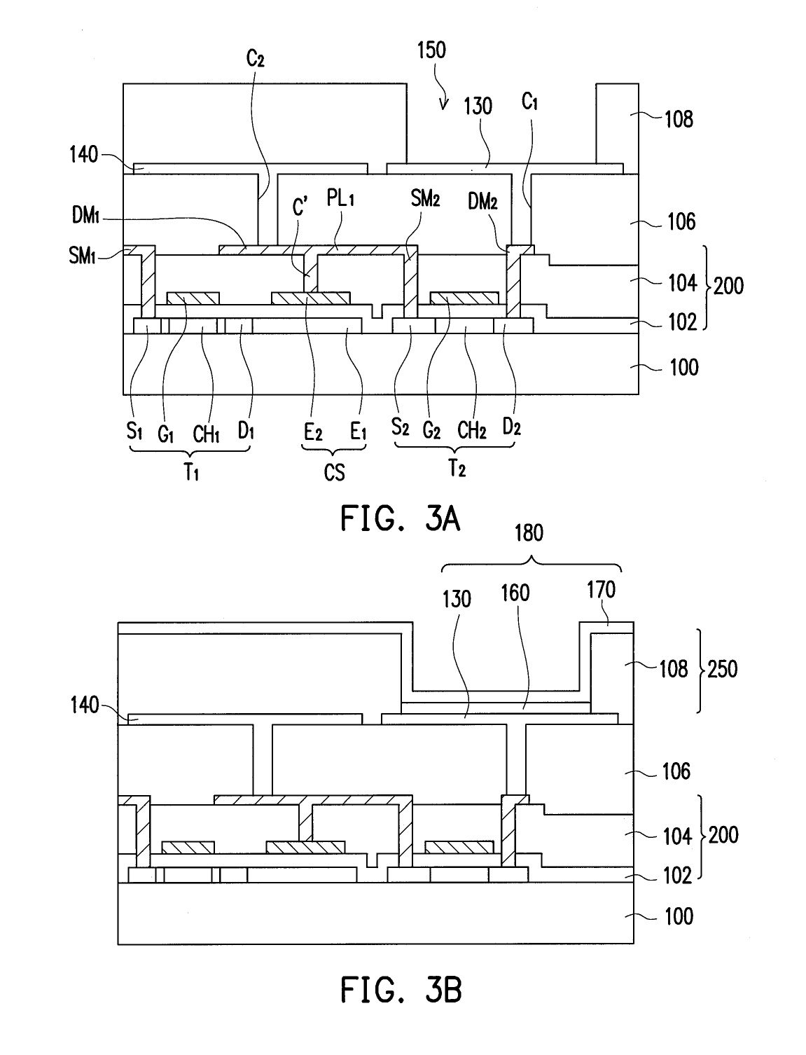

FIG. 1 is a top view of an electroluminescence device according to one embodiment of the present invention. FIG. 2 is a top view of a portion of the pixel array of the electroluminescence device of FIG. 1. FIG. 3A is a schematic cross-sectional view of a portion of a pixel structure according to an embodiment of the present invention. In order to clearly illustrate the embodiment, the light emitting layer and the second electrode layer of the light emitting device of the pixel structure in FIG. 2 and FIG. 3A are omitted. The complete cross-sectional view of the pixel structure is shown in FIG. 3B.

Referring to FIG. 1 and FIG. 2, the electroluminescence device of the embodiment has a display region 101, the display region 101 includes a plurality of pixel regions 110, and each pixel region 110 has a pixel structure therein, so as to form a pixel array. The region around the display region 101 does not function as displaying, and thus it is also called a non-display region or a peripheral circuit region.

In particular, each pixel region 110 has a light-emitting region 120 and a non-light-emitting region 122 (as shown in FIG. 2). Generally, a transparent electrode is disposed in the light-emitting region 120 for transmission of light. Driving devices and wires of the pixel structure are disposed in the non-light-emitting region 122. In the pixel region 110 of the embodiment, the non-light-emitting region 122 surrounds the light-emitting region 120, and therefore the light-emitting region 120 is disposed inside the non-light-emitting region 122. In addition, the position of the devices in the non-light emitting region 122 does not limit in the present invention, even though the devices in the non-light emitting region 122 in FIG. 2 are all disposed at an upper portion of the pixel region 110. According to another embodiment, the devices in the non-light emitting region 122 can also be distributed at an upper portion and a lower portion of the pixel region 110, and the light-emitting region 120 is disposed in a middle portion of the pixel region 110.

In order to clearly illustrate the pixel structures of the present invention, a single pixel structure is described as an example in the following description. The pixel array of an electroluminescence device comprises a plurality of pixel structures which are the same or similar. Therefore, people skilled in the art can understand the structure of the pixel array of an electroluminescence device according to the single pixel structure in the following description.

Referring to FIG. 2, FIG. 3A and FIG. 3B, the pixel structure in the pixel region 110 comprises a device layer 200 and a light emitting device layer 250 on a substrate 100 (see FIG. 3B). The device layer 200 comprises a scan line SL, a data line DL₁, a power line PL₁, a first active device T₁ and a second active device T₂. The light emitting device layer 250 comprises a light emitting device 180 and an auxiliary electrode layer 140.

The substrate 100 may be a transparent substrate such as a transparent glass substrate or a transparent flexible substrate. The substrate 100 is mainly used to support components of the electroluminescence device. In order to enable the light emitted by the electroluminescence device to penetrate through the substrate 100, the substrate 100 is made of a transparent or light transmitting material. Electroluminescence devices that emit light passing through the substrate 100 are also generally referred to as bottom-emitting electroluminescence devices.

In the device layer 200, the pixel structure in each pixel region 110 is electrically connected with one scan line SL, one data line DL₁, and one power line PL₁ so as to control the pixel structure. In other words, the pixel array comprising a plurality of pixel structures includes a plurality of scan lines SL, a plurality of data lines DL₁˜DL₃ and a plurality of power lines PL₁˜PL₃. In a preferred embodiment, each pixel region 110 comprises active devices T₁, T₂ and a capacitor CS formed therein. In the present embodiment, the devices in each pixel region 110 are illustrated as having two active devices and one capacitor (2T1C), it is noted that this is for the purposes of illustration only and therefore should not be regarded as limiting. Rather, the present invention is not intended to limit the number of the active devices and capacitor in each pixel region 110. In the 2T1C pixel structure, the active device T₁ has a gate G₁, a source S₁, a drain D₁, and a channel CH₁. The source S₁ is electrically connected with the data line DL₁, the gate G₁ is electrically connected with the scan line SL, and the drain D₁ is electrically connected with the active device T₂. The active device T₂ has a gate G₂, a source S₂, a drain D₂, and a channel CH₂. The gate G₂ of the active device T₂ is electrically connected with the drain D₁ of the active device T₁. The source S₂ of the active device T₂ is electrically connected with the power line PL₁. One terminal E₁ of the capacitor CS is electrically connected with the drain D₁ of the active device T₁, and the other terminal E₂ of the capacitor CS is electrically connected with the power line PL₁ through a contact window C′ in the insulating layer 104.

In the embodiment, the active devices T₁, T₂ are illustrated as top-gate thin-film transistors (also referred to as poly-silicon thin-film transistors). In other words, the source S₁, drain D₁ and channel CH₁ of the active element T₁ are formed within a semiconductor layer (poly-silicon layer, for example). A lightly doped drain region (LDD) is further formed between the source S₁ and channel CH₁ and between the drain D₁ and channel CH₁. A gate insulating layer 102 is formed between this semiconductor layer and the gate G₁, and another insulating layer 104 is formed over the gate G₁. The source S₁ is electrically connected with the data line DL₁ through a source metal layer SM₁ that extends through the insulating layers 104, 106. The drain D₁ is electrically connected with the gate. G₂ of the active element T₂ through a drain metal layer DM₁ that extends through the insulating layers 104, 106. Besides, the source S₂, drain D₂ and channel CH₂ of the active element T₂ are formed within a semiconductor layer (poly-silicon layer). Similarly, the gate insulating layer 102 is formed between this semiconductor layer and the gate G₂, and another insulating layer 104 is formed over the gate G₂. The source S₂ is electrically connected with the power line PL₁ through a source metal layer SM₂ that extends through the insulating layers 104, 106. The drain D₂ is electrically connected with a drain metal layer DM₂ that extends through the insulating layers 104, 106.

In the present embodiment, the active elements T₁, T₂ are illustrated as top-gate thin-film transistors (also referred to as poly-silicon thin-film transistors). However, this is for the purposes of illustration only and therefore should not be regarded as limiting. In other embodiments, the active elements T₁, T₂ may also be bottom-gate thin-film transistors (also referred to as amorphous silicon thin-film transistor). In addition, the device layer 200 shown in FIG. 2, FIG. 3A and FIG. 3B are for the purposes of illustration only and should not be regarded as limiting. Rather, in other embodiments, the pixel structures may be configured and arranged in a different manner.

The active device layer 200 is covered by another insulating layer 106. The light emitting device layer 250 is disposed on the insulating layer 106, and the light emitting device layer 250 comprises the light emitting device 180 and the auxiliary electrode layer 140.

The light emitting device 180 of the light emitting device layer 250 includes a first electrode layer 130, a light emitting layer 160, and a second electrode layer 170.

The first electrode layer 130 is disposed on the surface of the insulating layer 106 and is electrically connected with the drain D₂ of the active element T₂. In the present embodiment, the first electrode layer 130 is electrically connected with the drain metal layer DM₂ of the active element T₂ through a contact window C₁ formed in the insulating layer 106. The first electrode layer 130 can be a transparent electrode layer and can be, for example, made of indium tin oxide (ITO) or indium zinc oxide (IZO). Besides, another insulating layer 108 is formed over the first electrode layer 130. The insulating layer 108 has an opening 150 that exposes the first electrode layer 130. In each pixel region 110, the area occupied by the opening 150 is substantially equal to or slightly less than the area occupied by the first electrode layer 130.

The light emitting layer 160 is disposed on the first electrode layer 130 exposed from the opening 150. The light emitting layer 160 may be an organic light emitting layer or inorganic light emitting layer. The electroluminescence device may be referred as an organic electroluminescence device or an inorganic electroluminescence device depending upon the material of the light emitting layer 160. Besides, the light emitting layer 160 in each pixel region 110 can be a red organic light emitting pattern, green organic light emitting pattern, blue organic light emitting pattern, or multiple color (e.g. white, orange, purple) light emitting pattern formed by mixing a desired spectrum of lights.

The second electrode layer 170 is formed over the light emitting layer 160 and extends to the surface of the insulating layer 108. In the present embodiment, the second electrode layer 170 is an unpatterned electrode layer, and therefore, the second electrode layer 170 in all pixel regions 110 are electrically connected with one another. The second electrode layer 170 may be a metal electrode layer or a transparent conductive layer.

In another embodiment, the light emitting device 180 may further include an electron injecting layer, a hole injecting layer, an electron transporting layer and a hole transporting layer.

The auxiliary electrode layer 140 is electrically connected with the power line PL₁. In the embodiment, the auxiliary electrode layer 140 is disposed on the surface of the insulating layer 106 and electrically connected with the power line PL₁ through the contact window C₂ in the insulating layer 106. In particular, the auxiliary electrode layer 140 does not contact with the first electrode layer 130 of the light emitting device 180. In addition, the auxiliary electrode layer 140 and the first electrode layer 130 of the light emitting device 180 are formed by the same layer. In other words, the auxiliary electrode layer 140 and the first electrode layer 130 of the light emitting device 180 are formed by the same layer and are separated from each other. Therefore, the material of the auxiliary electrode layer 140 can be the same to that of the first electrode layer 130 of the light emitting device 180. According to the embodiment, the auxiliary electrode layer 140 and the first electrode layer 130 of the light emitting device 180 are formed by the same layer and are separated from each other. Since the first electrode layer 130 partially overlaps with the active device T₂, the auxiliary electrode layer 140 can be disposed in the pixel region 110 where the first electrode layer 130 is not disposed, for example, the auxiliary electrode layer 140 can be disposed above the active device T₁, the power line PL₁, the data line DL₁, the scan line SL or a combination thereof. Therefore, the auxiliary electrode layer 140 substantially shields the active device T₁, the power line PL₁, the data line DL₁, the scan line SL or a combination thereof. Of course, the auxiliary electrode layer 140 of each pixel region 110 may further extend to an adjacent pixel region.

It is noted that, as shown in FIG. 2, the auxiliary electrode layer 140 in all of the pixel regions 110 are electrically connected with each other. In addition, the auxiliary electrode layer 140 in the pixel regions 110 is electrically connected with the power line PL₁˜PL₃ respectively. That is, the currents on the power line PL₁˜PL₃ are transported by the power line PL₁˜PL₃ and the auxiliary electrode layer 140. The auxiliary electrode layer 140 and the power line PL₁˜PL₃ are equal to two wires which are electrically connected in parallel. Therefore, the auxiliary electrode layer 140 can reduce the equivalent resistance of the power line PL₁˜PL₃. As a result, the voltage drops occurred at different pixel regions can be reduced, so as to improve the overall light emitting uniformity of the electroluminescence device.

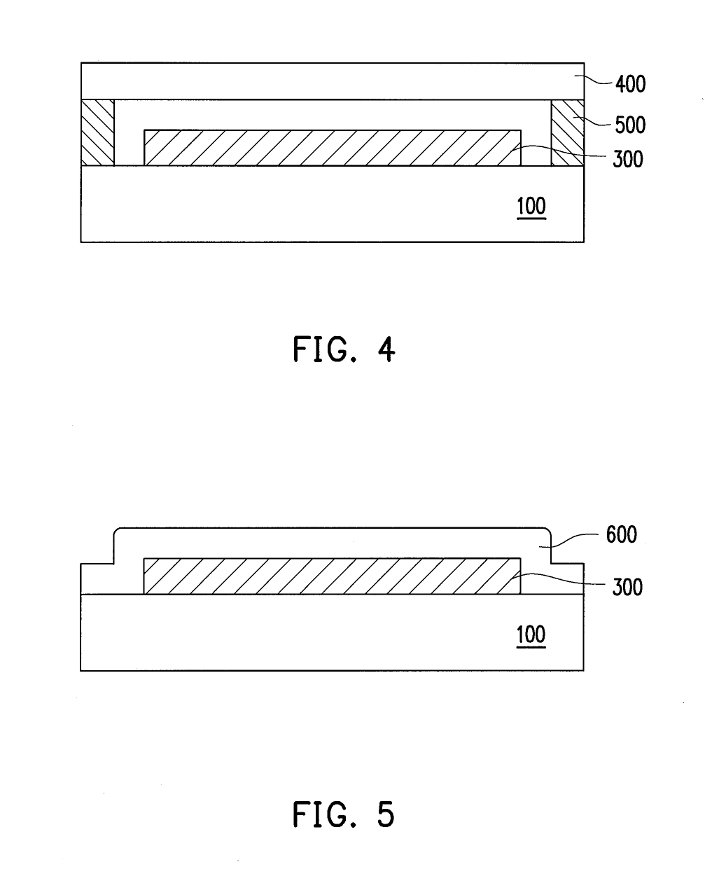

After the pixel structures of the electroluminescence device are formed on the substrate 100, an encapsulating process for the electroluminescence device is performed to complete the electroluminescence device. The encapsulating process for the electroluminescence device is shown in FIG. 4. That is, a covering plate 400 is disposed above the pixel array 300 of the electroluminescence device on the substrate 100. The covering plate 400 is fixed on the substrate 100 through a sealant 500, such that the pixel array 300 (comprised of pixel structures) is sealed between the substrate 100 and the covering plate 400. Certainly, other materials, such as a desiccating material or a filler material, may also be filled in the space between the substrate 100 and the covering plate 400.

According to another embodiment, the encapsulating process for the electroluminescence device is shown in FIG. 5. That is, directly depositing or coating a protective layer 600 on the substrate 100 to cover the pixel array 300 (comprised of the above mentioned pixel structures). The protective layer 600 may be an organic material, an inorganic material or a combination thereof.

Furthermore, according to another embodiment yet, the embodiments of FIG. 4 and FIG. 5 are combined. That is, the pixel array 300 (comprised of the above mentioned pixel structures) is covered by the protective layer 600, and then the covering plate 400 is disposed above the substrate 100.

The pixel structure shown in FIG. 2, FIG. 3A and FIG. 3B are a pixel structure of an electroluminescence device. However, using the auxiliary electrode layer to reduce the equivalent resistance of the power line does not limit to apply to the pixel structure of an electroluminescence device. In other words, using the auxiliary electrode layer to reduce the equivalent resistance of the power line can also be applied to other pixel structures which have the problem of poor overall light emitting uniformity owing to obvious voltage drop on the power line.

To sum up, the auxiliary electrode layer is formed in the pixel structure and the auxiliary electrode layer is electrically connected with the power line. The auxiliary electrode layer and the power line are equal to two wires electrically connected in parallel, and therefore the auxiliary electrode layer can reduce the equivalent resistance of the power line. As a result, the voltage drops occurred at different pixel regions can be reduced, so as to improve the overall light emitting uniformity of the electroluminescence device.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A pixel structure of an electroluminescence device, disposed in a display region, the display region having a light-emitting region and a non-light-emitting region, the pixel structure comprising:
a first active device, electrically connected with a scan line and a data line;
a second active device, electrically connected with the first active device and a power line;
a light emitting device, disposed in the light-emitting region and electrically connected with the second active device, the light emitting device comprising:
a first electrode layer, electrically connected with the second active device;
a light emitting layer disposed on the first electrode layer; and
a second electrode layer disposed on the light emitting layer; and
an auxiliary electrode layer, electrically connected with the power line.

2. The pixel structure as claimed in claim 1, wherein the first electrode layer of the light emitting device does not contact with the auxiliary electrode layer.

3. The pixel structure as claimed in claim 1, wherein the first electrode layer of the light emitting device and the auxiliary electrode layer are formed by the same layer.

4. The pixel structure as claimed in claim 1, wherein a material of the first electrode layer of the light emitting device is the same as that of the auxiliary electrode layer.

5. The pixel structure as claimed in claim 1, wherein the auxiliary electrode layer substantially shields the first active device.

6. The pixel structure as claimed in claim 1, further comprising a capacitor, wherein one terminal of the capacitor is electrically connected with the first active device, and another terminal of the capacitor is electrically connected with the power line and the second active device.

7. The pixel structure as claimed in claim 1, further comprising:
a first insulating layer covering the first active device and the second active device, wherein the first electrode layer of the light emitting device and the auxiliary electrode layer are respectively disposed on a surface of the first insulating layer; and
a second insulating layer disposed on the first insulating layer, wherein the second insulating layer has an opening exposing the first electrode layer of the light emitting device, and the light emitting layer of the light emitting device is disposed on the first electrode layer exposed by the opening,
wherein the second electrode layer of the light emitting device covers the second insulating layer and the light emitting layer of the light emitting device.

8. The pixel structure as claimed in claim 7, wherein the first insulting layer further comprises:
a first contact window, wherein the second device and is electrically connected with the first electrode layer of the light emitting device through the first contact window; and
a second contact window, wherein the power line is electrically connected with the auxiliary electrode layer through the second contact window.

9. The pixel structure as claimed in claim 1, wherein the light emitting layer is an organic light emitting layer or an inorganic light emitting layer.

10. The pixel structure as claimed in claim 1, wherein the auxiliary electrode layer substantially shields the data line.

11. An electroluminescence device, comprising:
a substrate, having a display region, wherein the display region has a light-emitting region and a non-light-emitting region;
a plurality of scan lines and a plurality of data lines disposed in the non-light-emitting region;
at least a power line; and
a plurality of pixel structures, disposed in the display region, wherein each of the pixel structures comprises:
a first active device, electrically connected with one corresponding scan line and one corresponding data line;
a second active device, electrically connected with the first active device and the power line;
a light emitting device, disposed in the light-emitting region and electrically connected with the second active device, the light emitting device comprising:
a first electrode layer, electrically connected with the second active device;
a light emitting layer disposed on the first electrode layer; and
a second electrode layer disposed on the light emitting layer; and
an auxiliary electrode layer, electrically connected with the power line.

12. The pixel structure as claimed in claim 11, further comprising a covering plate disposed above the substrate, wherein the pixel structures are sealed between the substrate and the covering plate.

13. The display apparatus as claimed in claim 11, further comprising a protective layer disposed on the substrate and covering the pixel structures.

14. A pixel structure, comprising:
a first active device, electrically connected with a scan line and a data line;
a second active device, electrically connected with the first active device and a power line;
a electrode layer, electrically connected with the second active device;
an auxiliary electrode layer, electrically connected with the power line.

15. The pixel structure of claim 14, wherein the electrode layer does not contact with the auxiliary electrode layer.

16. The pixel structure of claim 14, wherein the electrode layer and the auxiliary electrode layer are formed by the same layer.

17. The pixel structure of claim 14, wherein a material of the electrode layer is the same to that of the auxiliary electrode layer.

18. The pixel structure as claimed in claim 14, wherein the auxiliary electrode layer further covers a portion of the scan line and a portion of the data line.

19. The pixel structure as claimed in claim 14, further comprising a capacitor, wherein one terminal of the capacitor is electrically connected with the first active device, and another terminal of the capacitor is electrically connected with the power line and the second active device.

20. The pixel structure as claimed in claim 14, further comprising an insulating layer covering the first active device and the second active device, wherein the electrode layer and the auxiliary electrode layer are respectively disposed on a surface of the insulating layer, and wherein the insulating layer comprises:
a first contact window, electrically connected with the second device and the electrode layer; and
a second contact window, electrically connected with the power line and the auxiliary electrode layer.
